(19) United States
(12) Patent Application Publication
(10) Pub. No.: US 2017/0154557 A1
(43) Pub. Date: Jun. 1, 2017

(54) IMAGE DISPLAY APPARATUS, DRIVING METHOD THEREOF, AND COMPUTER-READABLE RECORDING MEDIUM

(71) Applicant: Samsung Electronics Co., Ltd., Suwon-si (KR)

(72) Inventors: Chang-ho SHON, Seoul (KR); Ki-ock SHIN, Suwon-si (KR); Ji-yong PARK, Suwon-si (KR); Sang-kyun IM, Seoul (KR); Young-hoon CHO, Suwon-si (KR)

(73) Assignee: Samsung Electronics Co., Ltd., Suwon-si (KR)

(21) Appl. No.: 15/351,997

(22) Filed: Nov. 15, 2016

(30) Foreign Application Priority Data
Nov. 30, 2015 (KR) 10-2015-0168773

(51) Int. Cl. G09G 3/00; G09G 3/3258; G09G 3/3233; G09G 3/3266; G09G 3/3275

(52) U.S. Cl. CPC G09G 3/006; G09G 3/3266; G09G 3/3275; G09G 3/3233; G09G 3/3258; G09G 2300/0452; G09G 2310/08

(57) ABSTRACT

An image display apparatus, a driving method thereof, a computer-readable recording medium and controller are provided. The method includes receiving video data, determining valid data used to determine pixel failure of a display panel by determining a pixel value of each sub pixel in the received video data, generating detection data based on an applied pixel value of the sub pixel in response to the video data being applied to the display panel, and determining the pixel failure by determining a state of the generated detection data corresponding to the determined valid data.

### CROSS-REFERENCE TO RELATED APPLICATIONS

This application claims priority from Korean Patent Application No. 10-2015-0168773, filed on Nov. 30, 2015, in the Korean Intellectual Property Office, the disclosure of which is incorporated herein by reference in its entirety.

### BACKGROUND

1. Field

Apparatuses and methods consistent with exemplary embodiments relate to an image display apparatus, a driving method thereof, a computer-readable recording medium and a controller, and more particularly, to an image display apparatus which determines pixel failure based on video data of a displayed image in response to the image being displayed in a television (TV), a driving method thereof, and a computer-readable recording media.

2. Description of the Related Art

In light emitting diode (LED) display apparatuses, electrical open/short of LED pixels may occur due to environmental damages or LED lifespan over time. The term “open/short” may refer to a state that the pixels may not be operated through control from the outside and the pixels may always be disconnected or may always be electrically short-circuited due to an abnormal electrical operation. The “environmental damage” may refer to a state that the pixels may be damaged due to external shocks and the like in response to the display apparatus being exposed to the public in a place such as a waiting room of a bus terminal. The term “LED lifespan” may refer to degradation according the long-term element use and the like. Accordingly, in response to the open/short being caused in the LEDs due to several factors, a pixel may be represented with a different color from a neighboring color or may affect a neighboring pixel value. The wrong image output or displayed may be prevented by controlling the intensity of the neighboring color or replacing the corresponding LED.

In response to a pulse width modulation (PWM) method being used to determine failure of the LED element in the related art, the open/short and normal operation of the LED element may be determined by applying a voltage value of full white to pixels and then determining output values output through a comparator.

However, since a separate task for outputting a full white screen is necessary to determine the failure of the pixel in the related method, the element failure determination may be cumbersome.

### SUMMARY

Additional aspects and/or advantages will be set forth in part in the description which follows and, in part, will be apparent from the description, or may be learned by practice thereof.

Exemplary embodiments may overcome the above disadvantages and other disadvantages not described above. Also, an exemplary embodiment is not required to overcome the disadvantages described above, and an exemplary embodiment may not overcome any of the problems described above.

One or more exemplary embodiments relate to an image display apparatus which determines pixel failure based on video data of a displayed image in response to the image being displayed in a television (TV), a driving method thereof, and a computer-readable recording medium.

According to an aspect of an exemplary embodiment, there is provided a driving method of an image display apparatus, the method including receiving video data; determining valid data used to determine pixel failure of a display panel by determining a pixel value of each sub pixel in the received video data; generating detection data based on an applied pixel value of the sub pixel in response to the video data being applied to the display panel; and determining the pixel failure by determining a state of the generated detection data corresponding to the determined valid data.

The determining of the valid data may include determining the determined pixel value as the valid data in response to the determined pixel value being equal to a setup value.

The setup value may be determined by a reference value applied to a comparator to generate the detection data.

The determining of the valid data may include determining the valid data in the received video data using a unit frame image as a block unit in which the unit frame image is divided into a plurality of blocks.

The determining of the valid data may include generating a determination result as bit information.

The generating of the detection data may include detecting the pixel value applied to the sub pixel; comparing the detected pixel value with a preset reference value; and generating a comparison result as the detection data.

The method may further include storing a determination result of pixel failure for a first region of the display panel; storing a determination result of pixel failure for a second region of the display panel; and determining pixel failure for all pixels of the display panel based on the stored determination results for the first region and the second region.

The method may further include, in response to the determining of the pixel failure for all the pixels of the display panel being completed, notifying a user of the completion of the determining.

The method may further include, in response to the number of pixels determined as the pixel failure being more than a preset threshold value, notifying a user of exceeding of the number of pixels determined as the pixel failure.

The method may further include changing pixel values for neighboring pixels of a pixel determined as the pixel failure in the received video data.

According to an aspect of an exemplary embodiment, there is provided an image display apparatus including a display panel configured to display received video data; and a processor configured to determine valid data used to determine pixel failure of the display panel by determining a pixel value of each sub pixel in the received video data, generate detection data based on an applied pixel value of the sub pixel in response to the video data being applied to the display panel, and determine the pixel failure by determining a state of the generated detection data corresponding to the determined valid data.

The processor may determine the determined pixel value as the valid data in response to the determined pixel value being equal to a setup value.

The setup value may be determined by a reference value applied to a comparator to generate the detection data.

The processor may determine the valid data in the received video data using a unit frame image as a block unit in which the unit frame image is divided into a plurality of blocks.

The processor may generate a determination result as bit information.

The processor may detect the pixel value applied to the sub pixel, compare the detected pixel value with a preset reference value, and generate a comparison result as the detection data.

The image display apparatus may further include a storage unit configured to store a determination result of pixel failure for a first region of the display panel and store a determination result of pixel failure for a second region of the display panel. The processor may determine pixel failure for all pixels of the display panel based on the stored determination results for the first region and the second region.

The processor may notify, in response to the determining of the pixel failure for all the pixels of the display panel being completed, a user of the completion of the determining.

The processor may notify, in response to the number of pixels determined as the pixel failure being more than a preset threshold value, a user of exceeding of the number of pixels determined as the pixel failure.

The processor may change pixel values for neighboring pixels of a pixel determined as the pixel failure in the received video data.

According to an aspect of an exemplary embodiment, there is provided a computer-readable recording medium including a program for executing a method of driving an image display apparatus, the method including receiving video data; determining valid data used to determine pixel failure of a display panel by determining a pixel value of each sub pixel in the received video data; generating detection data based on an applied pixel value of the sub pixel in response to the video data being applied to the display panel; and determining the pixel failure by determining a state of the generated detection data corresponding to the determined valid data.

According to an aspect of an exemplary embodiment, there is provided a testing method including determining whether a sub pixel of a pixel of video data is equal to a reference value; setting the sub pixel of the pixel as a test value when the sub pixel is equal to the reference value; applying the test value to a display panel; comparing display panel output to the test value; indicating the display panel is not defective when the display panel output equals the test value; and indicating the display panel is defective when the display panel output does not equal the test value.

The sub pixels within blocks of pixels of the display panel may be tested together.

The sub pixels within blocks of pixels of the display panel may be tested together where a tested number of pixels is less than an entire number of pixels of the display panel.

The testing may be applied all pixels of the display panel in test cycles.

The video data is applied to the display panel when the display panel is not defective.

According to an aspect of an exemplary embodiment, there is provided a testing method including determining whether sub pixels of corresponding pixels of video data are equal to a reference value where the pixels are less than all of the pixels of a display panel; setting the sub pixels of the pixels as a test values when the sub pixels are equal to the reference value; applying the test values to the display panel; comparing display panel outputs to the test value; indicating the display panel is not defective when the display panel outputs all equal the test values; and indicating the display panel is defective when the display panel outputs do not all equal the test value; and applying the video data to the display panel when the display panel is not defective.

According to an aspect of an exemplary embodiment, there is provided a controller for testing a display panel, the controller including a computer configured to determine valid data used to determine pixel failure of the display panel by determining a pixel value of each sub pixel in received video data for display on the display panel, generate detection data based on an applied pixel value of each sub pixel in response to the video data being applied to the display panel, and determine the pixel failure by determining a state of the detection data corresponding to the valid data.

Additional aspects and advantages of the exemplary embodiments are set forth in the detailed description, and will be obvious from the detailed description, or may be learned by practicing the exemplary embodiments.

### BRIEF DESCRIPTION OF THE DRAWINGS

The above and/or other aspects will be more apparent by describing certain exemplary embodiments with reference to the accompanying drawings, in which:

FIG. 1 is a block diagram illustrating a detailed configuration of an image display apparatus according to an exemplary embodiment;

FIG. 2 is block diagram illustrating a detailed configuration of an image display apparatus according to another exemplary embodiment;

FIG. 3 is block diagram illustrating a detailed configuration of an image display apparatus according to another exemplary embodiment;

FIG. 4 is a block diagram illustrating a detailed configuration of an interface illustrated in FIG. 3;

FIG. 5 is a diagram illustrating a configuration of a controller illustrated in FIG. 4;

FIG. 6 is a diagram illustrating a configuration of a controller illustrated in FIG. 3;

FIG. 7 is a block diagram illustrating a detailed configuration of a pixel state determination unit of FIG. 6;

FIGS. 8 and 9 are diagrams illustrating a pixel determination process according to an exemplary embodiment;

FIG. 10 is a block diagram illustrating a modified detailed configuration of a pixel state determination unit of FIG. 6;

FIG. 11 is a diagram illustrating a detailed configuration of a scan driver, a data driver, and a display panel according to an exemplary embodiment;

FIG. 12 is a diagram illustrating a switching element and a comparator corresponding to a unit pixel of FIG. 11; and

FIG. 13 is a flowchart illustrating a driving process of an image display apparatus according to an exemplary embodiment.

### DETAILED DESCRIPTION

Reference will now be made in detail to the embodiments, examples of which are illustrated in the accompanying drawings, wherein like reference numerals refer to the like elements throughout. The embodiments are described below by referring to the figures.

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

The terms “first”, “second”, etc. may be used to describe diverse components, but the components are not limited by the terms. The terms are only used to distinguish one component from the others.

The terms used in the present application are only used to describe the exemplary embodiments, but are not intended to limit the scope of the disclosure. The singular expression also includes the plural meaning as long as it does not differently mean in the context. In the present application, the terms “include” and “consist of” designate the presence of features, numbers, steps, operations, components, elements, or a combination thereof that are written in the specification, but do not exclude the presence or possibility of addition of one or more other features, numbers, steps, operations, components, elements, or a combination thereof.

In the exemplary embodiment of the present disclosure, a “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor (not shown).

Products that the embodiments described herein may be applied may not be limited to products which display an image. For example, the product group that the embodiments described herein may be applied may be an apparatus which may display an image such as a TV, a desktop computer, a laptop computer, a tablet personal computer (PC), a portable phone, a portable multimedia player (PMP), an MP3, and a wearable apparatus, a peripheral apparatus which communicates with the image display apparatus, for example, a set top box which communicates with a TV, an image processing apparatus such as a main body which communicates with a computer monitor, and the like. Accordingly, the product group is not limited to the image display apparatus. For clarity, the image display apparatus as the product group will be exemplarily described.

Hereinafter, the present disclosure will be described in detail with reference to the accompanying drawings.

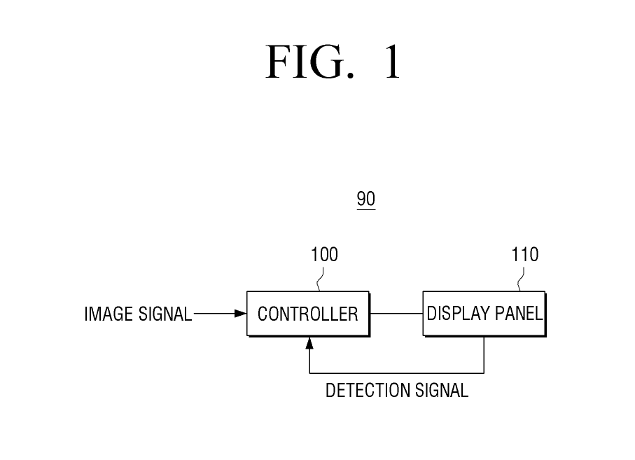

FIG. 1 is a block diagram illustrating a detailed configuration of an image display apparatus according to an exemplary embodiment.

As illustrated in FIG. 1, an image display apparatus 90 according to an exemplary embodiment may include a part or all of a controller 100 and a display panel 110.

Here, the phrase “include a part or all” may mean that the image display apparatus 90 may be configured in such a manner that a part of components such as the controller 100 is omitted or integrated into other components such as the display panel 110. For a thorough understanding of the inventive concept, the image display apparatus 90 will be described to include all the components. For example, the controller 100 may be implemented on the display panel 110 in a chip on glass (COG) manner. However, the controller 100 may not be formed in the chip form but may be simultaneously formed in the process of fabricating the display panel 110.

The controller 100 may receive an image signal provided from the outside. Here, the term “image signal” may refer to a signal including video data, audio data, and additional information, such as channel information. The image signal may be received in the controller 100 in various forms. For example, the image display apparatus 90 may directly receive the image signal provided from a broadcasting station or an Internet search portal enterprise in a compressed form or may receive the image signal from a set top box as a peripheral apparatus in a decompressed form. The image display apparatus 90 may receive the image signal in uncompressed form in a Blu-ray disc (BD) player and the like as a peripheral apparatus through a high-definition multimedia interface (HDMI) cable.

A detailed operation of the controller 100 may be changed according to a type of the received image signal, for example, received video data. For example, in response to the video signal being received in a compressed form, the video data may be decompressed and the decoding of the video data may be performed through the image display apparatus 90 or through a set top box. Accordingly, description for the controller 100 will be made on the assumption that the video data is received in a decompressed form.

In response to the video data being received, the controller 100 may transfer the received video data to the display panel 110 so that an image may be implemented or produced on a display screen. In the process, the controller 100 may determine pixel failure or failed pixels for pixels or sub pixels of the display panel 110, for examples, red (R), green (G), and blue (B) sub pixels based on the received video data. In general, the term “pixel” may refer to a pixel in which R, G, and B sub pixels are integrated. For example, in response to the display panel 110 being configured of individual R, G, B LED elements, the controller 100 may determine failure of the individual R, G, and B LED elements. In response to the R, G, and B LED elements being fabricated in chips to form one package, the R, G, and B LED elements may be replaced in or as a package through failure determination.

To determine the pixel failure of the display panel 110, the controller 100 to be described in detail later may determine test data, for example, valid data available to determine the pixel failure from video data before the video data is applied to the display panel 110. The determining of the valid data may be performed by determining whether or not a pixel value of a sub pixel included in the video data is equal to a setup value. The controller 100 may display the received video data on the display panel 110 and then generate detection data based on the pixel value applied to each pixel. The generated detection data may refer to a comparison result of a detection value detected with respect to the pixel value or test value applied to the pixel and a reference value applied to a comparator from the outside. For example, for a sub pixel, when no difference between the detection value and the reference value applied to the comparator exists the sub pixel is normal, and the comparator may output a signal indicating that the sub pixel is normal. When a difference between the detection value and the reference value applied to the comparator does existthe sub pixel is defective, and the comparator may output a signal indicating that the sub pixel is defective. Here, the reference value applied to the comparator may be equal to the above-described setup value. The controller 100 may determine a state of the detection data corresponding to the determined valid data. For example, in response to the valid data and the detection data being compared in block units with respect to the received video data, the controller 100 may determine the state of the detection data corresponding to the same position as a position of the valid data. For example, the controller 100 may determine the valid data and the detection data relate to a sub pixel at a specific position of the display panel 110. In response to a result value of the detection data corresponding to the position of the valid data or test data being determined to a value indicating open/short of the pixel, for example, the LED element as a determination result, the controller 100 may determine the sub pixel of the display panel 110 corresponding to the corresponding position to be defective.

On the basis of the display panel 110, the controller 100 may determine pixel failure for all pixels of the display panel 110 based on the valid data extracted from the video data before the video data is applied to the display panel 110 and the detection data generated based on the pixel value of the sub pixel after the video data is applied to the display panel 110. The controller 100 may use the video data corresponding to several tens of frames applied to the display panel 110 to perform the determining of the pixel failure for all the pixels. The determining operation may be temporarily periodically performed according to a request of the user.

The display panel 110 may include a LED panel or an organic LED (OLED) panel which implements an image through self-emission. The display panel 110 may be fabricated by simultaneously forming a light-emitting element such as an LED or OLED in a process for forming a plurality of data lines and a plurality of scan lines on a substrate. The display panel 110 may be fabricated by assembling a LED module and the like, which are separately formed from a plurality of data lines and a plurality of scan lines, on the substrate in which the plurality of data lines and the plurality of scan lines are formed. Accordingly, the method of fabricating the display panel 110 is not limited to a particular fabricating method or an assembly method.

In the display panel 110 fabricated through the above-described process, pixel regions may be defined (or partitioned) through the plurality of data lines and the plurality of scan lines crossing each other. For example, the pixel region may be formed to be surrounded (or to be partitioned) by two lines. The individual R, G, and B LED elements may be assembled on the pixel region or the individual R, G, and B LED elements which are fabricated in one package form may be assembled on the pixel region. Here, the term “one package” may refer to a form that chips which R, G, and B lights emit are molded with a transparent resin. The display panel 110 may be fabricated in using a package form in which a specific color of the R, G, and B is repeated. For example, the display panel 110 may be fabricated by assembling R, R, G, and B chips, R, G, G, and B chips, or R, G, B, and B chips fabricated in package form. In another example, the display panel 110 may be fabricated by assembling a package including white (W), that is, R, G, B, and W chips fabricated in one package form. The display panel 110 having the above-described configuration may display an image on a screen in frame units by receiving the video data under control of the controller 100.

The display panel 110 according to an exemplary embodiment may further display a variety of information in addition to the received video data. For example, the display panel 110 may display a ratio of valid data, the number of valid data, and the like on a screen with respect to an image (for example, an image in block units or an image in frame units). In response to the coverage, that is, an amount that the pixel failure determination is completed being a fixed number or a fixed ratio or in response to the coverage being 100% completed, the display panel 110 may notify the user of the coverage state. In another example, in response to an error, that is, the number of pixels determined as the pixel failure or failed pixels being equal to or larger than a fixed number, the display panel 110 may notify the user of the number of pixels determined as the pixel failure or failed pixels.

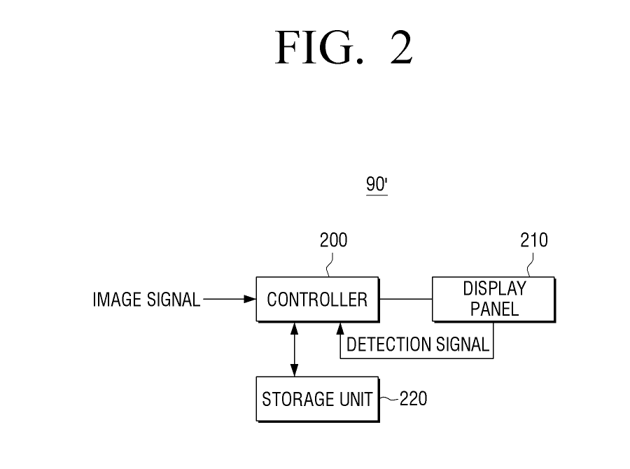

FIG. 2 is a block diagram illustrating a detailed configuration of an image display apparatus according to another exemplary embodiment.

As illustrated in FIG. 2, an image display apparatus 90′ according to another exemplary embodiment may include a part or all of a controller 200, a display panel 210, and a storage unit 220. Here, the phrase “include a part or all” may have the same meaning as the phrase “include a part or all” described in FIG. 1.

As compared with the controller 100 of FIG. 1, the controller 200 of FIG. 2 is different from the controller 100 in that the controller 200 may store a determination result of the valid data in received video data in the storage unit 220 configured a a read only memory (ROM) or random access memory (RAM) which is physically separated from the controller 200, and store the detection data generated based on the pixel value applied to the sub pixel after the video data is applied to the display panel 210 in the storage unit 220. It can be seen from the difference that the controller 100 of FIG. 1 may use an internal memory to store data or may store data in a software (for example, registry) form.

The determination result of the controller 200 may be stored in a bit information form. For example, the determination result of the controller 200 may be stored in a look-up table (LUT) form so that the determination result may be stored as bit information “1” in response to the pixel value being determined as valid data and the determination result may be stored as bit information “0” in response to the pixel value being determined as invalid data. In this example, the determination result stored in the storage unit 220 may be stored in units of unit frames or the determination result stored in the storage unit 220 may be stored in block units (for example, 8×8, 16×16, and the like) or in horizontal line units constituting the unit frame. Accordingly, the method of storing the determination result is not limited to any one method. However, in terms of cost and the like, the determination result of the controller 200 may be stored in block units rather than in units of unit frames and then the stored result may be deleted after the determination result is used for the determination of the pixel failure.

For example, the controller 200 may calculate the determination result for the pixel failure by comparing the valid data stored in the LUT in the storage unit 220 and the detection data stored in the LUT in units of a unit frame. The controller 200 may store the calculated detection result in the storage unit 220 again. The calculated determination result may be stored in the storage unit 220 together with coordinate information. The controller 200 may adjust pixel values of neighboring pixels of a pixel determined as a defective pixel according to the information of the defective pixel stored in the storage unit 220 and output the adjusted pixel values to the display panel 210. In response to a separate request from the user, the controller 200 may display corresponding data in the display panel 210 or provide the corresponding data to an external server or a storage medium such as a universal serial bus (USB).

The operation of the storage unit 220 illustrated in FIG. 2 may also be performed through the controller 100 of FIG. 1. The controller 200 and the display panel 210 of FIG. 2 are not largely different from the controller 100 and the display panel 110 of FIG. 1 other than the above-described operation of the storage unit 220, and thus detailed description thereof will be omitted.

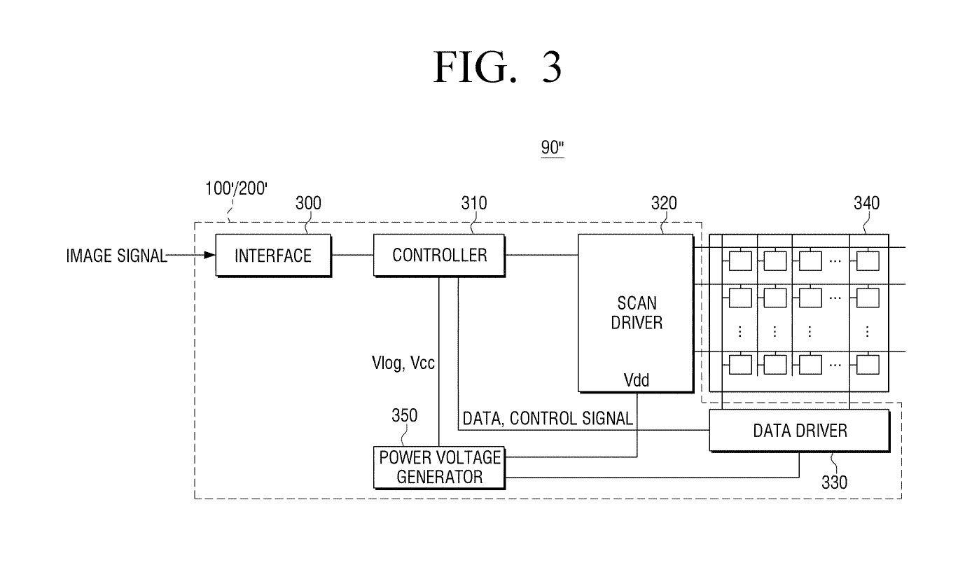

FIG. 3 is a block diagram illustrating a detailed configuration of an image display apparatus according to another exemplary embodiment.

As illustrated in FIG. 3, an image display apparatus 90″ according to another exemplary embodiment may include a part or all of an interface 300, a controller 310, a scan driver 320, a data driver 330, a display panel 340, and a power voltage generator 350.

Here, the phrase “include a part or all” may mean that the image display apparatus 90″ may be configured in such a manner that a part of the components, such as the interface 300 is omitted (for example, may be configured in a set top box) or the scan driver 320 and/or the data driver 330 are integrated into the display panel 340. For a thorough understanding of the inventive concept, the image display apparatus 90″ will be described to include all the components.

The interface 300 may be, for example, an image board, such as a graphic card, and may be configured to convert video data input from the outside of the system to match with a resolution of the image display apparatus 90″ and output the converted video data. For example, the video data may be configured of, for example, 8-bit or more R, G, and B video data. The interface 300 may generate control signals such as a clock signal DCLK and vertical/horizontal synchronous signals Vsync and Hsync corresponding to the resolution of the image display apparatus 90″. The interface 300 may provide the vertical/horizontal synchronous signals Vsync and Hsync and the video data to the controller 310.

The controller 310 may generate a control signal which controls the scan driver 320 and the data driver 330 to display the input R, G, and B video data on the display panel 340. The controller 310 may represent gray scale information of the R, G, and B video data using a logic voltage Vlog provided from the power voltage generator 350. For example, in response to the R gray scale information being generated using the logic voltage of 3.3 V, the controller 310 may generate 8-bit information ‘10001001’ by representing 3.3 V as “1” and 0 V as “0”.

The controller 310 may generate a gate shift clock (GSC), a gate output enable (GOE) signal, a gate start pulse (GSP), and the like as a gate control signals for controlling the scan driver 320. Here, the GSC may be a signal which determines a turn on/off timing of a switching element coupled to a light-emitting element such as R, G, and B LEDs (or OLEDs), the GOE signal may be a signal which controls an output of the scan driver 320, and the GSP may be a signal which indicates a first driving line of a screen in one vertical synchronous signal.

The controller 310 may generate a source sampling clock (SSC), a source output enable (SOE) signal, a source start pulse (SSP), and the like as a data control signal. The SSC may be used as a sampling clock for latching data in the data driver 330, the SOE signal may be a signal for transferring data latched through the SSC to the display panel 340, and the SSP may be a signal for indicating latch start or sampling start of data during one horizontal synchronous period.

For example, in response to the data driver 330 being configured as a TLC 5958 series chip from Texas Instruments, the controller 310 according to an exemplary embodiment may be configured to process a signal such as a data signal, a serial data shift clock (S CLK), a LAT, a gray scale (GS) PWM reference clock (G CLK), and the like together with the corresponding IC. The data signal may be R, G, and B gray scale data. The S CLK may be a signal for shifting data input to the data driver 330 to a shift register (for example, 48-bit common shift register (MSB) in synchronization with a rising edge of the S CLK. Data stored in the shift register may be shifted to the MSB at every rising edge of the S CLK. The LAT may be a signal for latching data from the MSB to a memory (for example, GS data memory) at a falling edge of the LAT. The G CLK may be a signal for increasing a GS counter by one at every rising edge of the G CLK for PWM control. The various signals may be modified, and thus this is not limited thereto.

Accordingly, the controller 310 may be a timing controller for determining an output timing of video data and may include a control signal generator (not shown). The controller 310 may further include a data rearrangement unit (not shown) and the like. The control signal generator may generate a control signal to display a unit frame image in a corresponding time in response to a time for displaying the unit frame image in the display panel 340 being 16.7 ms. The data rearrangement unit may reprocess the input R, G, and B data in conformity with the display panel 340. For example, an operation of converting 8-bit data to 64-bit data and the like may be performed.

The controller 310 may determine pixel failure or defective pixels of the display panel 340 as described above. For example, the controller 310 may determine the valid data available to determine the pixel failure in the video data before the video data is applied to the display panel 340, generate detection data based on a pixel value applied to each sub pixel in response to the video data being applied to the display panel 340, and generate a determination result with reference to the determined valid data. The determination result may be stored together with coordinate information. For example, it may be assumed that a pixel value of a sub pixel corresponding to a coordinate (1, 1) of the display panel 340 in the received video data is determined as the valid data and the detection data generated based on the pixel value applied to the sub pixel of the corresponding position indicates an abnormal state of an LED element. Accordingly, the controller 310 may determine the sub pixel of the position corresponding to the valid data as a defective pixel.

Since the determining of the pixel failure of the display panel 340 is performed on all the pixels, the controller 310 may determine valid data in the video data corresponding to several to several tens of frames. For example, in response to the pixel failure for a first region of the display panel 340 from first five unit frames being determined, the controller may further analyze next unit frames to determine the pixel failure for a second region of the display panel 340 that the pixel failure may not have been determined yet. The determining of the pixel failure may be performed in a pixel state determination unit of the controller 310. In response to the determination test being completed only by about 30% of all the pixels due to a current dark image, the controller 310 may estimate a determination result, coordinate information, and the like for remaining 70% of pixels based on the determination result for 30% of pixels.

In response to pixel failure for all the pixels of the display panel 340 being completely determined through analysis of several to several tens of frames in the above-described process, the controller 310 may notify the user of the determination completion. The controller 310 may notify the user of the number of defective pixels in response to the number of defective pixels being equal to or larger than a fixed number. The notifying may be performed by a method of outputting sound through a sound output unit such as a speaker or a method of displaying a message in the display panel 340. The notifying method may be performed through a request to a controller of the interface 300 from the controller 310. The configuration related to the notifying may be modified at any degree, and thus the configuration is not limited thereto.

The scan driver 320 may receive gate on/off voltages Vdd/Vss provided from the power voltage generator 350 and apply corresponding voltages to the display panel 340 according to control of the controller 310. In the embodiment, the gate off voltage Vss may be designed to be a ground voltage. The gate on voltage Vdd may be sequentially provided from a scan line 1 GL1 to a scan line N GLn of the display panel 340 to implement a unit frame image in the display panel 340. In the embodiment, the scan driver 320 may operate in response to a scan signal generated in the controller 310. For example, the scan driver 320 to be described later may include a switching element coupled between a power voltage source Vdd and each scan line. For example, the switching element may include a thin film transistor (TFT) element. In another example, the switching element may include a bipolar transistor TR and a MOSFET.

The data driver 330 may simultaneously provide video data corresponding to one horizontal line to the display panel 340 or provide sequentially video data to the display panel for every horizontal line by converting R, G, and B video data as serial data provided from the controller 310 into parallel data as digital data and converting the digital data to an analog current or a duty cycle current (for example, pulse current). For example, digital information of the video data provided from the controller 310 may be converted into the analog current which can represent a color gray scale and may be provided to the display panel 340. The analog current may be a pulse-type current. The data driver 330 may also output unit frame data in synchronization with a gate signal provided to the scan driver 320.

The detailed configuration of the data driver 330 is apparent to those skilled in the art. Therefore, detailed description thereof will be omitted. For example, the data driver 330 may be variously configured according to a driving method of a light-emitting element, for example, according to a constant current driving method or a constant voltage driving method. For clarity, a current source will be simply represented to indicate the constant current in the exemplary embodiment. The data driver 330 may include a TLC 5958 series IC of TI.

In the display panel 340, a plurality of scan lines and a plurality of data lines which cross each other to define pixel regions may be formed and R, G, and B light-emitting elements, such as LEDs or OLEDs, may be formed in the pixel regions which are defined by the plurality of scan lines and the plurality of data lines crossing each other. In response to a current path being formed between each scan line and the ground through the data driver 330 after the power voltage is applied to the scan line of the display panel 340, the light-emitting elements may generate currents corresponding to gray scan information thereof through data lines coupled to a corresponding scan line to which the power voltage is provided. The display panel 340 according to an exemplary embodiment may display an image by controlling brightness according to a current amount flowing through the current path. The light-emitting element may be driven through a constant voltage and thus the driving method is not limited to the constant current driving method.

The power voltage generator 350 may generate a direct current (DC) voltage having various levels by receiving a commercial power voltage, for example, an alternating current (AC) voltage of 110 V or 220 V from the outside and output the generated DC voltage. The power voltage generator 350 may generate a voltage having various levels and provide the generated voltage. For example, the power voltage generator 350 may generate a DC voltage of 3.3 V as the logic voltage for the controller 310 and provide the generated voltage to represent the gray scale. In another example, the power voltage generator 350 may generate a DC voltage of 4.5 V as the gate on voltage Vdd for the scan driver 320 and provide the voltage to the scan driver. In response to the controller 310, the scan driver 320, and the data driver 330 being configured in an IC form, the power voltage generator 350 may generate a Vcc voltage input to the IC.

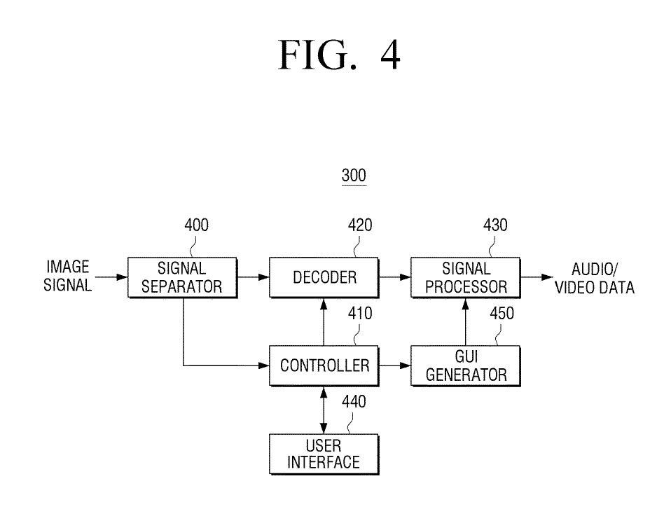

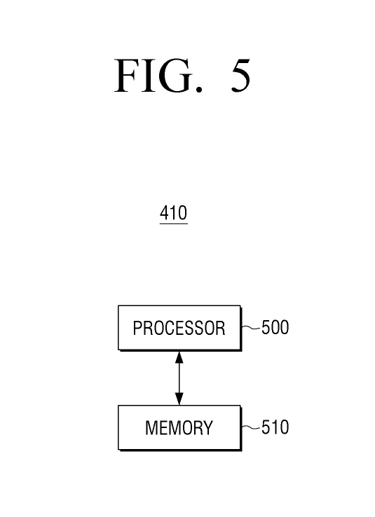

FIG. 4 is a block diagram illustrating a detailed configuration of the interface illustrated in FIG. 3 and FIG. 5 is a diagram illustrating a configuration of the controller of FIG. 4.

As illustrated in FIG. 4, a tuner (not shown), a demodulator (not shown), the interface 300 may include a part or all of a signal separator 400, a controller 410, a decoder 420, a signal processor 430, a user interface 440, and a graphic user interface (GUI) generator 450, and may further include an image analyzer.

Here, the phrase “include a part or all” may mean that a part of components such as the tuner, the demodulator, and the image analyzer are omitted. For a thorough understanding of the inventive concept, the embodiment will be described to include all the components.

For example, the tuner may perform a tuning operation for receiving a specific broadcasting program provided from an external broadcasting station according to the user's request received through the user interface 440, and the demodulator may demodulate an image signal input through the tuner. In this example, the demodulator may restore the modulated image signal as the original signal. The signal separator 400 may divide the demodulated image signal into video/audio data and additional information. The decoder 420 may decode the separated video/audio data and the signal processor 430 may perform an operation of converting the decoded audio data to match with a speaker and the like. The controller 410 may control the decoder 420, the GUI generator 450, and the like. For example, the user interface 440 may receive a request signal which requests an output of an electronic program guide (EPG) screen, a menu screen for setting various functions, and the like to the display panel 340 or various request signals related to the determination of pixel failure. In response to the EPG output request, the controller 410 may control the GUI generator 450 based on the received user's request. The GUI generator 450 may provide a graphic corresponding to the EPG screen to the signal processor 430 and the signal processor 430 may combine the video data and the EPG graphic and output a combined result.

The controller 410 may be, for example, a microcomputer (MICOM) circuit, and may include a processor 500 and a memory 510 as illustrated in FIG. 5. The processor 500 may be a central processing unit (CPU), and may include a control circuit, an arithmetic logic unit (ALU), a command interpreter, a register group, and the like. The configuration of the processor 500 is apparent to those skilled in the art, and thus detailed description thereof will be omitted. The processor 500 may perform an actual control operation on the various components constituting the image display apparatus 90″, and the memory 510 may store information such as additional information or processing data processed under control of the controller 500.

The image analyzer may not be included in the controller 310 illustrated in FIG. 3 but may be included in the interface 300. The installation position of the image analyzer may be determined by a system designer. As described above, the image analyzer may serve to determine the valid data available to determine the pixel failure of the display panel 340 in the received video data. In this aspect, the image analyzer may refer to a (valid data) determination unit.

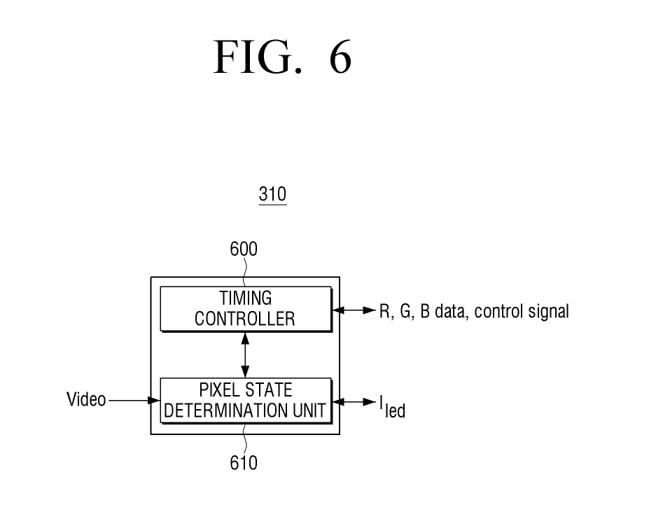

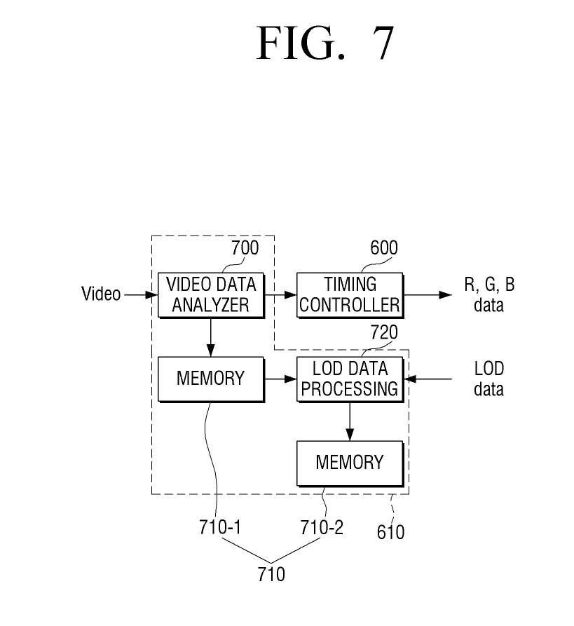

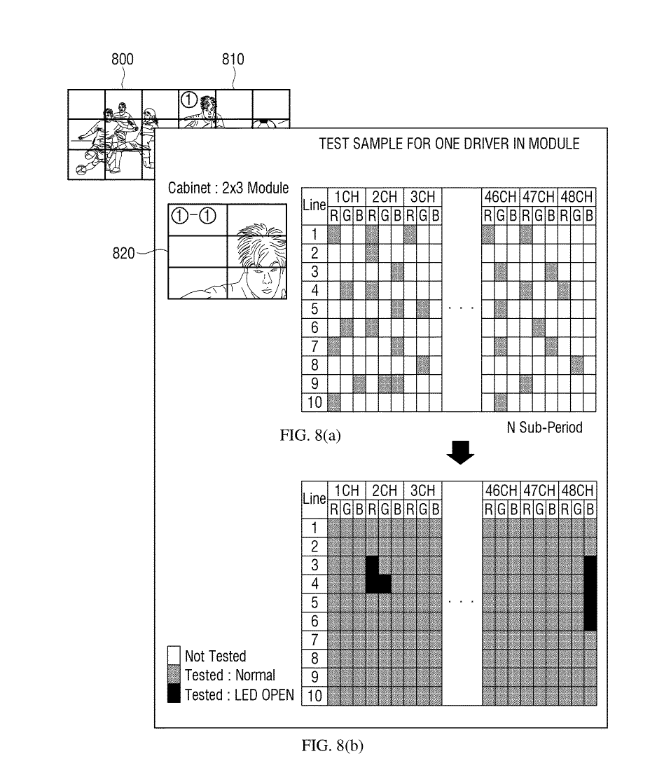

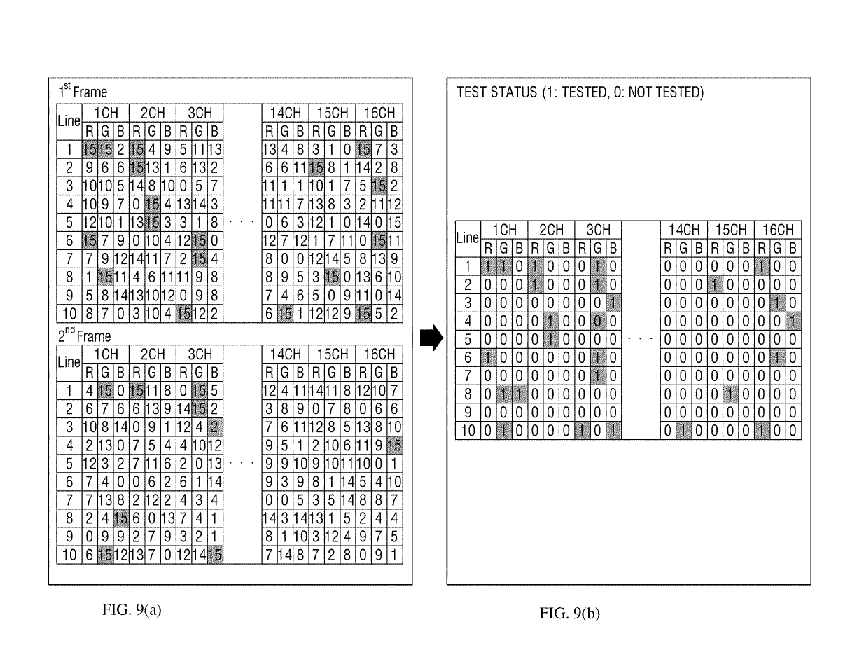

FIG. 6 is a diagram illustrating a configuration of the controller 310 illustrated in FIG. 3, FIG. 7 is a block diagram illustrating a detailed configuration of a pixel state determination unit of FIG. 6, and FIGS. 8 and 9 are diagrams illustrating a pixel failure determination process according to an exemplary embodiment.

As illustrated in FIG. 6, the controller 310 according to an exemplary embodiment illustrated in FIG. 3 may include a timing controller 600 and a pixel state determination unit 610.

As described above, the timing controller 600 may perform an operation for controlling an output timing of the received video data. For example, the timing controller 600 may perform an operation of generating a control signal, rearranging input R, G, and B data, and the like. In this example, the timing controller 600 may include a control signal generator and a data rearrangement unit. The timing controller 600 may provide the generated control signal to the scan driver 320 and the data driver 330 of FIG. 3 and provide the R, G, and B data to the data driver 330.

The pixel state determination unit 610 may determine the valid data or test data used to determine the pixel failure in the video data before the video data is applied to the display panel 340. The determining of the valid data may be related to performance of a comparator configured in the data driver 330. For example, a criterion for determining the valid data may be a reference value Vref input to the comparator. In this example, in response to the reference value of the comparator being determined to a pixel value of a sub pixel corresponding to a 200-th gray scale of 256 gray scales, that is, a gray scale value, the determination criterion of the valid data, that is, a setup value may be a value corresponding to the 200-th gray scale.

The pixel state determination unit 610 may determine the valid data, that is, a pixel used to determine the pixel failure in the received video data, and determine the pixel failure based on a determination result of a pixel value of the pixel after the determined valid data, that is, the pixel value of the pixel is applied to the display panel 340. For example, the pixel state determination unit 610 may determine that a sub pixel is normal in response to a pixel value of the sub pixel determined as the valid data being normally detected after the pixel value of the sub pixel determined as the valid data is applied to the display panel 340 and the pixel is defective in response to the pixel value of the sub pixel being abnormally detected after the pixel value of the sub pixel is applied to the display panel 340.

To perform the above-described function, the pixel state determination unit 610 may include a part or all of an image analyzer 700, a storage unit 710, and a data processor 720 as illustrated in FIG. 7. Here, the phrase “include a part or all” may have the same meaning as the phrase “include a part or all” described above.

The image analyzer 700 may perform an image analysis operation for determining the pixel failure of the display panel 340 in response to the user's request through the user interface 440 of FIG. 4. For example, the image analyzer 700 may perform a determination operation of the valid data available to determine the pixel failure. In this example, the image analyzer 700 may determine the valid data by determining whether or not the pixel value of the sub pixel in the received video data is equal to the setup value. Here, the term “setup value” may have the same meanings as the reference value Vref input to the comparator of the data driver 330 as described above. For example, the setup value and the reference value may be a value corresponding to the 200-th gray scale.

As illustrated in FIG. 8, the image analyzer 700 may determine the valid data in a block unit image 820 to determine the valid data in the received video data. Since it can be seen that the received video data is substantially decoded in block units in the interface 300 of FIG. 3, the image analyzer 700 may receive the block unit video data with respect to unit frame images 800 and 810 in decoding order. The image analyzer 700 may determine the valid data with respect to the block unit video data. FIG. 8(a) illustrates a determination result of valid data with respect to pieces of block unit video data constituting one unit frame. FIG. 8(b) illustrates a result of finally determining the pixel failure using detection data LOD data generated based on a pixel value applied to each sub pixel after the block unit video data is applied to the display panel 340 of FIG. 3.

Since the image analyzer 700 determines the valid data with respect to the plurality of block unit images 820 constituting the unit frame images 800 and 810 as illustrated in FIG. 8 and ensures the valid data for all pixels to determine pixel failure for all the pixels of the display panel 340, the image analyzer 700 may determine the valid data or test data with respect to several to several tens of unit frames as illustrated in FIG. 9(a). Then, the image analyzer 700 may store the determination result in a LUT form in a storage unit 1 710-1.

The data processor 720 may compare the detection data generated based on the pixel value applied to the sub pixel after the received video data is applied the display panel 340 and the valid data. For example, the pixel value of the sub pixel determined as the valid data may be applied to a sub pixel in a specific position of the display panel 340 and the data processor 720 may compare the detection data generated based on the applied pixel value of the sub pixel with the valid data. In this example, the data processor 720 may determine whether the detection data corresponding to the sub pixel determined as the valid data is normal or defective. For example, in response to sub pixels corresponding to coordinates (1, 1) and (2, 1) in the received video data represented with a unit frame being determined as the valid data, the data processor 720 may determine the detection data of the sub pixels corresponding to the corresponding positions. In the process, the data processor 720 may acquire the detection data by requesting the detection data from the data driver 330 and may acquire the detection data by requesting the detection data by an amount to be compared.

For example, the data processor 720 may acquire the detection data corresponding to a size of the valid data stored in the storage unit 1 710-1 from the data driver 330. The data processor 720 may determine the pixel failure by comparing the valid data or test data and the detection data and store a determination result in a storage unit 2 710-2. For example, a determination result may record whether or not the determination is performed on specific pixels as illustrated in FIG. 9(b) and may record whether the pixel is normal or defective as bit information in response to the pixel failure determination being performed. In the process, the data processor 720 may store the determination result together with a coordinate value with respect a sub pixel finally determined as the pixel failure in the storage unit 2 710-2.

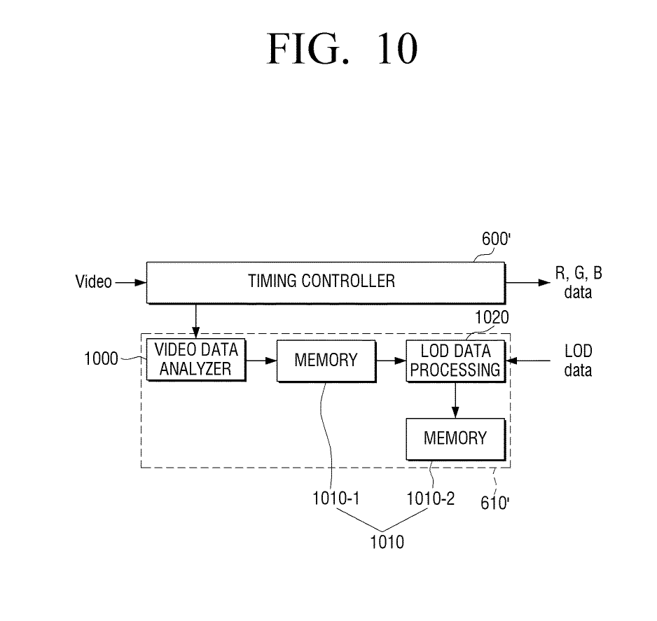

FIG. 10 is a block diagram illustrating a modified detailed configuration of the pixel state determination unit of FIG. 6.

As illustrated in FIG. 10, a pixel state determination unit 610′ may directly receive data from the interface 300 of FIG. 3 but may receive the data from a timing controller 600′ of FIG. 10.

For example, the timing controller 600′ may convert resolution of the received video data to match with resolution of the display panel 340 as described above. In this example, an image analyzer 1000 of the pixel state determination unit 610′ may receive R, G, and B data reprocessed from the timing controller 600′.

Other than the above-described operation, the pixel state determination unit 610′ of FIG. 10 is not largely different from the pixel state determination unit 610 of FIG. 7, and thus detailed description thereof will be omitted.

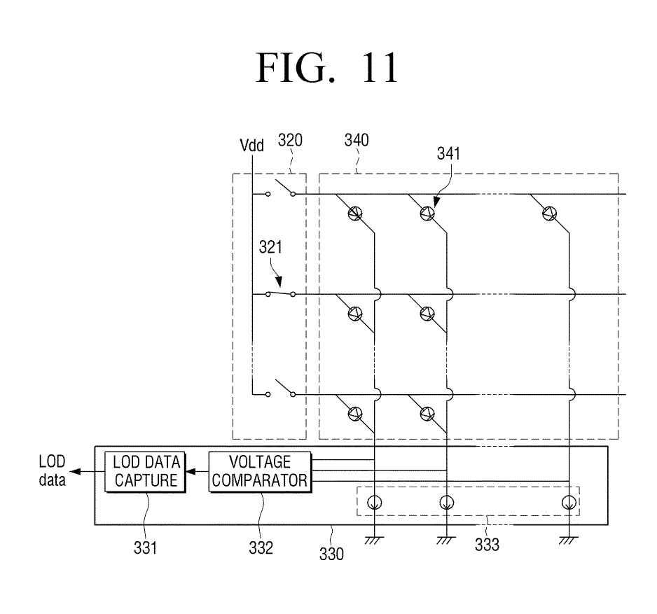

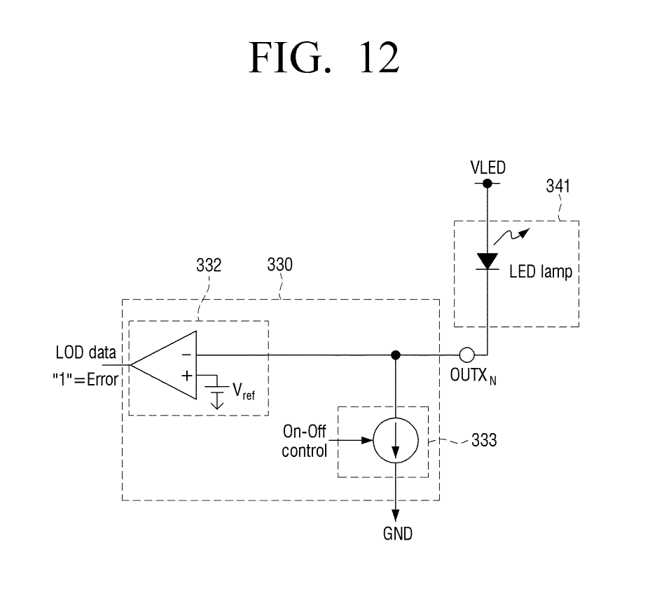

FIG. 11 is a diagram illustrating a detailed configuration of a scan driver, a data driver, and a display panel according to an exemplary embodiment, and FIG. 12 is a diagram illustrating a switching element and a comparator corresponding to a unit pixel of FIG. 11.

For clarity, referring to FIG. 11 with FIG. 10, the timing controller 600′ according to an exemplary embodiment may sequentially apply the power voltage Vdd to scan lines in the scan driver 320. A switching element 321 coupled to each scan line may be controlled through the applied power voltage Vdd.

After the power voltage is applied to one scan line, the timing controller 600′ may apply pixel data to a switching unit 333 of the data driver 330. The pixel value of the pixel data may be represented through switching control by a PWM method. For example, the timing controller 600′ may control an intensity of current flowing through a light-emitting element 341 of the display panel 340 by adjusting a turn-on time of the switching element 333. Since a current amount flowing through the light-emitting element 341 is increased in response to the turn-on time being increased, the pixel value having a large gray scale may be represented.

In response to the pixel value of the pixel data being represented in the light-emitting element 341, a comparator 332 may determine whether or not a corresponding pixel is defective by detecting the current flowing through a sub pixel of the display panel 340, that is, the light-emitting element 341. For example, as illustrated in FIG. 12, in response to the reference value Vref input to the comparator 332 being set to a value corresponding to the 200-th gray scale level of the pixel value and the current value detected through the light-emitting element 341 corresponding to a specific sub pixel being a value corresponding to the 200-th gray scale level, no difference may exist between two input voltages and thus the comparator 332 may output a comparison result which determines that the sub pixel is normal. For example, the comparator 332 may be an operational amplifier. The comparator 332 may output ‘zero (0)’ indicating a normal state of the sub pixel in response to no difference existing between a non-inverting terminal (+) and an inverting terminal (−) of the comparator 332 and output ‘1’ indicating an abnormal state of the sub pixel in response to the difference existing, and vice versa. The operation of the comparator 332 may be determined by the system designer.

The comparator 332 may generate detection data based on a detection value detected every scan line and provide the generated detection data to a data capture unit 331. The data capture unit 331 may store the received detection data in a memory and the like. The data capture unit 331 may be a memory, but the data capture unit 331 may further include a controller and the like. According, the data capture unit 331 may provide the detection data by a required amount by control or a request of a data processor 1020 of FIG. 10.

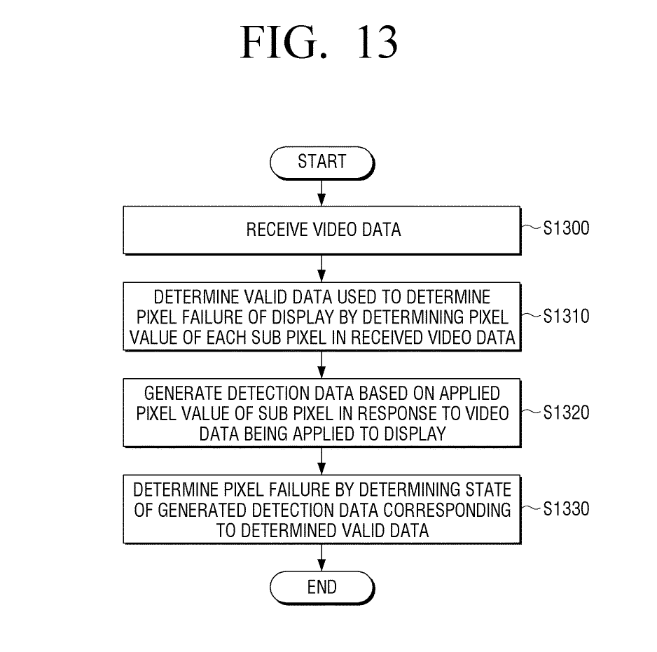

FIG. 13 is a flowchart illustrating a driving process of an image display apparatus according to an exemplary embodiment.

For clarity, referring to FIG. 13 with FIG. 1, the image display apparatus 90 according to an exemplary embodiment may receive video data (S1300). The received video data may be video data of a broadcasting image or data provided from a peripheral BD reproducer and the like.

The image display apparatus 90 may determine valid data used to determine pixel failure of a display (or display panel) by determining a pixel value or test value of each sub pixel (for example, R, G, and B) in the received video data (S1310). For example, the image display apparatus 90 may determine whether or not the pixel value is equal to a setup value and the “setup value” may be a pixel value indicating a specific gray scale level in response to 256 gray scale levels.

The image display apparatus 90 may generate detection data based on an applied pixel value of the sup pixel (or based on a detection value of the pixel value) in response to the video data being applied to the display (S1320). For example, the image display apparatus 90 may detect the pixel value applied to the sub pixel using a size of current or voltage. The image display apparatus 90 may generate a comparison result of the detected detection value and a reference value as the detection data. The “reference value” may have the same size as the setup value.

The image display apparatus 90 may determine the pixel failure by determining a state of the detection data corresponding to the determined valid data (S1330). The term “corresponding” may mean that the pixel value of the sub pixel determined as the valid data and the detection data generated based on the pixel value are corresponding to a sub pixel at the same position in the display. For example, in response to the pixel value of the sub pixel determined as the valid data being a pixel value of the sub pixel corresponding to the coordinate (1, 1) in the display, the detection data generated based on the pixel value applied to the sub pixel of the corresponding coordinate may be determined.

The operation of determining the pixel failure described above according to the exemplary embodiment may be completed in response to the valid data for all the pixels of the display being ensured. To ensure the valid data for all the pixels, the image display apparatus 90 may determine the valid data from the video data of several or several tens of frames and the image display apparatus 90 may determine the valid data in a state that the unit frame image is divided in block units in the process.

As a result, the image display apparatus 90 may determine the pixel failure in real time without an effect on a currently output image. The image display apparatus may estimate a (determination) result value with respect to pixels which are not currently determined through a coverage function. For example, the determination result value of the determination result which is not obtained through the current determination process may be estimated from the determination result obtained in the prior determination process.

It has been described that all the components constituting the exemplary embodiment are combined in one or are combined to operate, but this is not limited thereto. For example, at least one or more of all the components may be selectively combined to operate within the object scope. Each of the components may be implemented with one piece of independent hardware, but a part or all of the components may be selectively combined to be implemented with computer program having a program module which performs a part or all of functions combined in one or a plurality of pieces of hardware. Codes and code segments constituting the computer program may be easily construed by those skilled in the art. The exemplary embodiment may be implemented by storing the computer program or method in a non-transitory computer-readable medium and reading and executing the computer program through a computer.

The non-transitory computer-readable medium is not a medium configured to temporarily store data such as a register, a cache, or a memory but an apparatus-readable medium configured to permanently or semi-permanently store data. For example, the programs may be stored in the non-transitory apparatus-readable medium such as a compact disc (CD), a digital versatile disc (DVD), a hard disc, a Blu-ray disc, a universal serial bus (USB), a memory card, or a read only memory (ROM), and provided

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

Although a few embodiments have been shown and described, it would be appreciated by those skilled in the art that changes may be made in these embodiments without departing from the principles and spirit thereof, the scope of which is defined in the claims and their equivalents.

What is claimed is:

1. A method of driving an image display apparatus, the method comprising:
receiving video data;
determining valid data used to determine pixel failure of a display panel by determining a pixel value of each sub pixel in the received video data;
generating detection data based on an applied pixel value of each sub pixel in response to the video data being applied to the display panel; and
determining the pixel failure by determining a state of the detection data corresponding to the valid data.

2. The method as claimed in claim 1, wherein the determining of the valid data includes determining the pixel value as the valid data in response to the pixel value being equal to a setup value, and
the setup value is determined by a reference value applied to a comparator to generate the detection data.

3. The method as claimed in claim 1, wherein the determining of the valid data includes determining the valid data in the received video data using a unit frame image as a block unit in which the unit frame image is divided into a plurality of blocks.

4. The method as claimed in claim 1, wherein the determining of the valid data includes generating a determination result as bit information.

5. The method as claimed in claim 4, wherein the generating of the detection data includes:
detecting the pixel value applied to each sub pixel;
comparing a pixel value with a preset reference value; and
generating a comparison result as the detection data.

6. The method as claimed in claim 1, further comprising:
storing a determination result of pixel failure for a first region of the display panel;
storing the determination result of the pixel failure for a second region of the display panel; and
determining pixel failure for all pixels of the display panel based on stored determination results for the first region and the second region.

7. The method as claimed in claim 6, further comprising, in response to the determining of the pixel failure for all the pixels of the display panel being completed, notifying a user of completion of the determining of the pixel failure for all the pixels of the display panel.

8. The method as claimed in claim 6, further comprising, in response to a number of pixels determined as the pixel failure being more than a preset threshold value, notifying a user of exceeding the preset threshold of the number of pixels determined as the pixel failure.

9. The method as claimed in claim 1, further comprising changing pixel values for neighboring pixels of a pixel determined as the pixel failure in the received video data.

10. An image display apparatus, comprising:
a display panel configured to display received video data; and
a processor configured to determine valid data used to determine pixel failure of the display panel by determining a pixel value of each sub pixel in the received video data, generate detection data based on an applied pixel value of each sub pixel in response to the video data being applied to the display panel, and determine the pixel failure by determining a state of the detection data corresponding to the valid data.

11. The image display apparatus as claimed in claim 10, wherein the processor determines the pixel value as the valid data in response to the pixel value being equal to a setup value.

12. The image display apparatus as claimed in claim 11, wherein the setup value is determined by a reference value applied to a comparator to generate the detection data.

13. The image display apparatus as claimed in claim 10, wherein the processor determines the valid data in the received video data using a unit frame image as a block unit in which the unit frame image is divided into a plurality of blocks.

14. The image display apparatus as claimed in claim 10, wherein the processor generates a determination result as bit information.

15. The image display apparatus as claimed in claim 14, wherein the processor detects the pixel value applied to each sub pixel, compares the pixel value with a preset reference value, and generates a comparison result as the detection data.

16. The image display apparatus as claimed in claim 10, further comprising a storage unit configured to store a determination result of pixel failure for a first region of the display panel and store the determination result of the pixel failure for a second region of the display panel,
wherein the processor determines pixel failure for all pixels of the display panel based on the determination results for the first region and the second region.

17. The image display apparatus as claimed in claim 16, wherein the processor notifies, in response to the determining of the pixel failure for all the pixels of the display panel being completed, a user of the completion of the determining of the pixel failure for all the pixels of the display panel.

18. The image display apparatus as claimed in claim 16, wherein the processor notifies, in response to a number of pixels determined as the pixel failure being more than a preset threshold value, a user of exceeding the preset threshold of the number of pixels determined as the pixel failure.

19. The image display apparatus as claimed in claim 12, wherein the processor changes pixel values for neighboring pixels of a pixel determined as the pixel failure in the received video data.

20. A non-transitory computer-readable recording medium including a program for executing a method of driving an image display apparatus, the method comprising:
receiving video data;
determining valid data used to determine pixel failure of a display panel by determining a pixel value of each sub pixel in the received video data;
generating detection data based on an applied pixel value of each sub pixel in response to the video data being applied to the display panel; and
determining the pixel failure by determining a state of the detection data corresponding to the valid data.
